(19) United States
(12) Patent Application Publication
(10) Pub. No.: US 2024/0327085 A1
(43) Pub. Date: Oct. 3, 2024

(54) MATERIAL FOR PACKAGING AGRICULTURAL PRODUCTS AND PRODUCTION METHOD OF A MATERIAL FOR PACKAGING AGRICULTURAL PRODUCTS

(71) Applicants: MINAS PACK FILMES E EMBALAGENS LTDA, Jacutinga (BR); NOK PARTICIPAÇÕES LTDA., Ribeirão preto (BR)

(72) Inventors: Denny OKUBO, Ribeirão Preto (BR); Aline Hurtado FIRMEZA, Jacutinga (BR)

(21) Appl. No.: 18/577,991

(22) PCT Filed: Jul. 8, 2022
(86) PCT No.: PCT/BR2022/050254

§ 371 Date: Jan. 9, 2024

(30) Foreign Application Priority Data
Jul. 10, 2021 (BR) 1020210136588

(51) Int. Cl. B65D 65/14; A01F 15/07; B65B 11/00

(52) U.S. Cl. CPC B65D 65/14; A01F 15/071; B65B 11/00

(57) ABSTRACT

The present invention is related to a new proposal for a material for packaging agricultural products, such as cotton, particularly in cylindrical bales through the use of automated agricultural machines and equipment, such as self-propelled balers. More particularly, the present invention relates to a packaging material which is formed by a single, continuous film (1) composed of a plurality of individual packaging portions (2) which are detachable from each other through a tear line (3), said individual packaging portion (2) having an initial portion (2a) and a final portion (2b), and wherein a permanent adhesive (10) is applied near the final end (5b) of the final portion (2b), which is covered by a film (12) whose end (12b), which overlaps said permanent adhesive (10), is folded into a “V” configuration, and the opposite end (12a) extends over the initial end (5a) of the initial portion (2a) of the subsequent individual packaging portion (2) where it is rigidly fixed.

### FIELD OF THE INVENTION

The present invention generally relates to a new material for packaging agricultural products, in particular for baling cotton, hay, straw and any other type of plant species of a forage nature, which are harvested and baled by means of automated agricultural equipment and machinery, for example, in harvesters and balers usually used in mechanized harvests, where the machine itself is capable of harvesting the field and, at the same time, threshing and packaging the harvested material in cylindrical bales that are collected at an opportune time and transported to processing centers.

More specifically, the material for packaging agricultural products, as well as the process of producing materials of this nature, according to the present invention, were designed and developed to improve the efficiency and productivity of crops, ensuring the adequate closure of bales and their proper maintenance in the field while waiting to be collected and during transport.

### BACKGROUND OF THE INVENTION

According to the prior art, several ways are known and used to promote the packaging of agricultural products, such as cotton, hay, straw and fodder in general, and this packaging occurs through harvesting and grouped into bales so that they can be transported more conveniently and safely to processing centers. Therefore, several types of materials are known that can be used for baling these agricultural products, being configured and selected according to the characteristics and properties of the vegetable crop that is being harvested and packaged. By way of example, materials made up of nets, tarpaulins and, in some cases, the combination of nets and tarpaulins, which are normally made of plastics, such as polyethylene or polypropylene, are quite common.

According to the prior art, with the development of numerous technologies applied in agriculture, several machines, equipment and devices designed and used to improve crop conditions are available, but mainly seeking to increase productivity in the field, whether in time of planting and harvesting. In connection herewith, some agricultural machines are known, also called harvesters or harvesting machines, which are self-propelled and capable of carrying out a continuous harvest without the need for prolonged stops, or even being removed from the field for, for example, emptying or transfer. of the harvested material for transfers and/or trailers responsible for transporting the materials to locations away from the field where they will be manipulated, processed and/or treated. Some machines, currently known and available on the market, reduce their displacement only to dump bales of products packed by the machine itself, for example in cotton harvesting processes.

More particularly regarding to cotton harvesting, without discarding hay, straw and fodder in general, it is quite common to use plastic sheets to wrap and package the harvested material, given the need to keep the material grouped together. and protected against the elements, in addition to facilitating transport from the field to the material handling, processing and treatment sites, which are normally far from the planting and harvesting area. Furthermore, mainly with regard to cotton harvesting, machines and equipment specially designed and developed for harvesting this type of crop are known in the prior art in view of the specificities and particularities that this type of vegetable culture requires, for example, short harvest time and fragility of the material in the face of bad weather.

As should be appreciated by those skilled in the art, these cotton harvesting machines are capable of carrying out a continuous harvest of the entire crop without interruptions. To this end, it is known that this type of machine has mechanisms that can collect the material in the field and, at the same time, process it, store it and even package it, forming individual bales of the harvested material that can be dumped in back in the field, which are opportunely collected by a tractor or other appropriate equipment and transported to the places where the harvested material is handled and processed. Thus, as can be seen, these bales generated by these machines are able to optimize and, consequently, significantly increase harvest productivity rates, at the same time that they guarantee the integrity of the harvested material, considering that the canvas used for the formation These bales form plastic wraps that protect the harvested material against adverse weather conditions while it is spread out in the field and waiting to be transported.

It is worth remembering that this technology of baling with canvas using automated machines was able to promote substantial advantages and improvements in the field, but mainly managed to reduce the levels of unhealthy conditions among workers and the workforce as a whole, considering that the harvests, In particular, cotton work has always been arduous and painful work, in which workers very frequently and easily got injured or fell ill, whether due to cuts on their hands, or due to weather conditions and long working hours in the field. Therefore, with the arrival of these technologies and the ability to automate and mechanize, in a certain way, the harvest, it became possible, in addition to improving the conditions of workers, to provide a significant increase in productivity and, also, generating great benefits to society., if the issue is analyzed from the perspective of human development.

In connection herewith, despite the evident benefits provided by these technologies, it was found that there were opportunities to provide improvements and improvements, particularly in relation to packaging material. More particularly, despite proving functional, it was found that the quality, resistance and even the production processes could be modified to obtain improvements and thus eliminate failures, problems and inconveniences that occurred with the technologies and materials known in the art, especially in the case of baling cotton in automated machines.

According to technologies known in the prior art, particularly with regard to packaging materials, some inconveniences related to production lines were identified which, in a certain way, interfere with the particularities required to allow automation in the material separation stage. for packaging and when closing the bale carried out inside cotton harvesters or other products. This is because, as can be seen, the materials used to pack cotton, hay, straw and forage in automated machines are made up of segments of plastic canvas interconnected by means of some adhesive element capable of keeping the segments interconnected and rolled into a coil, but that can be unrolled according to the demand required by the harvesting machine and, in the end, must allow the separation of the subsequent segment and, at the same time, ensure the closure of the bale before being dumped in the field for timely collection.

In this context, the manufacturing process of these plastic sheets for baling agricultural products in automated machines requires a step of assembling and connecting the segments that form a packaging portion to then roll up this sequence of individual packaging portions in order to obtain a coil that will be attached and used, for example, in automated cotton harvesters. By way of example, documents BRPI0307327-0, BRPI0511659-7, PCT/US2015/022330, PCT/AU2014/000821 and IN201303409 reveal plastic sheets formed by multiple segments fixed by means of connection to thus obtain a film continuous to be wound on a coil, and these connection means are obtained by combining areas with and without adhesives which, in some cases, are folded to form a type of protective layer that prevents the adhesive areas from sticking to the canvas when obtaining the coils and, thus, allowing their unwinding and separation within the machines.

As must be appreciated by those skilled in the art, these adhesive areas proved to be relatively essential according to the knowledge and practices adopted to date, since, in the final stage of forming the cotton bales inside the machines, the end of the packaging portion individual material needed to be adhered firmly and securely to prevent the bales from opening when dumped in the field and, eventually, being subjected to adverse weather conditions, especially in the case of cotton, which is a material with a tendency to expand and, consequently, forcing the canvas. in order to facilitate its rupture and/or opening.

Therefore, as can be seen, the process for manufacturing and assembling these coils is relatively complex and requires steps with a high level of precision to join the segments and packaging portions, which, logically, results in high manufacturing costs and, consequently, affects the productivity and profitability of crops.

The issue of costs is even more problematic when one observes that this material for packaging and forming bales of agricultural products is usually discarded without providing any financial return to the farmer, this is because, due to the characteristics and properties of the materials used in manufacturing of these tarpaulins, it becomes practically impossible to reuse and/or reintroduce this material into the production chain cycle of these raw materials. More specifically, the tarpaulins commonly applied and known in the art for packaging agricultural products in automated machines are materials composed of thermoplastic resins with very low recyclability.

Additionally, in some cases, some models of materials for packaging agricultural products known in the prior art presented an inconvenience related to the separation of the packaging portions at the end of the baling process inside the machines. In some cases, the cut performed to separate the portions of individual packages is not precise and, in most cases, this separation occurs by simply stretching the material until it breaks, which results in a totally irregular end with stretched parts that end up remaining loose, not adhered to the bale. These stretched and loose parts encourage the weakening of the bale as a whole, mainly due to the influence of rain and winds that can help to open or break the bale spontaneously in the field, which causes loss of part of the harvested material and, consequently, losses to the farmer.

In order to overcome the drawbacks presented above, a material was developed for packaging agricultural products essentially formed by a single and continuous film composed of a plurality of packaging portions, which are detachable from each other through a rupture line, with the packaging portion is divided into an initial portion and a final portion, the latter portion being provided with a layer of non-permanent adhesive on one of its surfaces, which makes it possible to promote the closure of the bale in an adequate manner. This type of material is the subject of protection, for example, in the patent processes BR102018067867-1 and BR102019018128-1, of the applicants themselves.

Despite proving to be highly efficient and meeting the needs of the vast majority of applications for baling agricultural products in automated machines, it was observed that this material could be improved, especially with regard to closing the bales, since, depending on the conditions of the harvesting site and the properties of the harvested and baled material itself, the need to apply a more resistant closure of the bales was observed because in some situations, combinations of climatic conditions and bad weather with the natural expansion properties, for example cotton, ended up allowing the bales to break and open and, consequently, the loss of the harvested material.

In this sense, observing the solutions known and available in the prior art to provide a means of closing bales, as reported above, it was noted that they did not appear to be efficient and viable, either from a technical and functional point of view or in relation to manufacturing costs and complexity.

Therefore, as can be seen, the state-of-the-art technologies used for baling agricultural products in automated machines do not appear to be adequate, economically viable and applicable to maintain the integrity of the harvested product packed in bales throughout the harvesting process, which begins with the formation of bales by automated machines, their exposure to the elements, and their transport and storage in handling and processing locations.

Thus, it is possible to state that these solutions known in the prior art for a material for packaging agricultural products in automated harvesters, for example for the harvesting of cotton, hay, straw and forage in general, reveal problems, limitations and inconveniences related to the complexity of processing in the coil production lines, until the moment the bales are finalized inside the machines and exposure to adverse weather conditions, also including risks to the environment when discarding the packaging material. And even those solutions developed by the depositors themselves proved capable of being improved to meet specific conditions that eventually require a more robust closure and, at the same time, viable from an economic and constructive point of view.

Thus, considering the scenarios and situations narrated above, it can be said that these are, among others, problems, inconveniences and improvements that are intended to be resolved, or minimally reduced, and achieved with the development of the present invention.

### DESCRIPTION OF THE INVENTION

Given the context presented above, it is one of the objectives of the present invention to provide a material for packaging agricultural products, such as cotton, hay, straw and fodder in general, in which said material was developed to be used in the processing process. baling carried out by automated harvesting machines. This packaging material, according to the present invention, is formed by technical, constructive and functional characteristics particularly designed to effectively solve the problems, limitations and inconveniences observed in the prior art, as reported above.

Thus, one of the objectives of the present invention is to provide a material for packaging agricultural products using automated harvesting machines whose characteristics seek to simplify the production lines and formation of coils made up of individual packaging portions, which were designed for the adequate baling of products. agricultural products inside the machines, but mainly to guarantee the integrity of the bales and, consequently, the packaged material. Therefore, due to the new packaging material proposal, according to the present invention, it becomes possible to eliminate farmers' losses and losses due to eventual breakage and/or opening of the bales while awaiting transportation in the field due to bad weather or even during transport to processing centers.

Still another objective of the present invention is to provide a material for packaging agricultural products that comprises constructive and structural aspects that continue to promote ideal separation between individual packaging portions in the final stage of the baling process within automated harvesting machines, but now, provide a more resistant closure of bales, eliminating the risk of breakage and spontaneous opening caused by very extreme weather conditions.

Additionally, it is also an object of the present invention to provide a material for packaging agricultural products in automated harvesting machines, which comprises stretching properties that provide a more balanced distribution of the expansion efforts generated by the packaged material and, thus, significantly improving the level of closure of the bales to guarantee their integrity, even when exposed to the strongest and most aggressive weather.

Therefore, it is one of the objectives of the present invention to provide a material for packaging agricultural products within automated harvesting machines that has physical and chemical properties developed to improve and increase the levels of protection of the harvested and baled agricultural product, whether in relation to structural aspects for withstand the expansion efforts of the baled material, as well as aspects involving the composition of the material, protect the agricultural product against rain, sun, dirt, dust, etc.

The present invention also aims to provide a method for manufacturing materials for packaging agricultural products, which is formed by steps designed and developed to simplify and reduce costs, but mainly to obtain a practical and functional solution for obtaining these materials in the with the aim of maintaining the constructive aspects necessary to be applied and used in the automated harvesting machines usually known and used in agriculture, especially for the harvesting of cotton, hay, straw and forage.

### SUMMARY OF THE DISCLOSURE

Thus, in order to obtain the objectives, improvements and technical and functional effects indicated above, among others, the present invention comprises a material for packaging agricultural products which is formed by a single and continuous film that is composed of a plurality of portions of individual packaging detachable from each other through a tear line, said portion of individual packaging having an initial portion and an end portion, wherein said material further comprises a permanent adhesive applied near the portion end, which is covered by a film the end of which, which overlies said permanent adhesive, is folded into a “V” configuration, and the opposite end extends over the initial end of the initial portion of the subsequent individual packaging portion where it is fixed.

Additionally, the present invention deals with a method of producing a material for packaging agricultural products, which is essentially formed by the following steps:
a) produce a single and continuous plastic film, through the formulation of the raw material and preparation of the film extruder;
b) produce said single and continuous plastic film in jumbo reels, which are subjected to inspection to be packaged and identified;
c) storage of said jumbo reel so that it can be applied to the single and continuous plastic film production line, where the following steps are carried out:
   c.1) unwind said jumbo reel;
   c.2) position and apply the signaling means, such as a metallized label;
   c.3) execute a rupture line on said single and continuous film, which is responsible for designing portions of individual packaging, with this rupture line being arranged between the final portion of an individual packaging portion and the initial portion of the subsequent individual packaging portion formed by the single, continuous film;
   c.4) apply a permanent adhesive near the final edge of the final portion;
   c.5) accommodate a film over the single, continuous film, so that the end, which overlaps the permanent adhesive, is folded forming a “V” configuration, and the opposite end extends over the initial end of the initial portion of the film. subsequent individual packaging portion;
   c.6) apply fastening elements to the end of said film;
   c.7) wind the single continuous film onto a reel to be introduced into an automated harvesting machine;
d) inspection of single and continuous film reels to be packaged and identified;
e) storing said reel of single and continuous film.

### BRIEF DESCRIPTION OF DRAWINGS

The characteristics, advantages and technical effects of the present invention, as highlighted above, will be better understood and more appropriately by a person skilled in the art based on the detailed description below, made by way of illustration only, and not restrictive, of particular embodiments, and with reference to the attached schematic figures, which:

FIG. 1 shows a top perspective view of a reel of material for packaging agricultural products, according to a first embodiment of the present invention, partially unrolled;

FIG. 2 shows a top view of the material separation region for packaging agricultural products, according to an embodiment of the present invention;

FIG. 3 shows a side view of the separation region of the material for packaging agricultural products, object of the present invention;

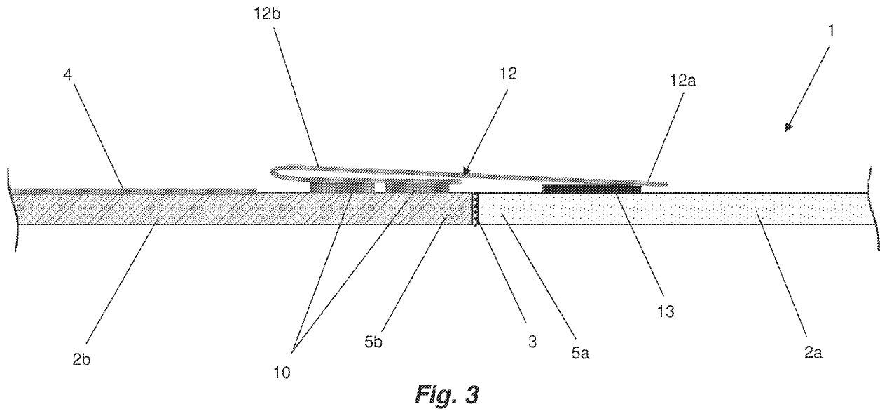

FIG. 4 shows a top view of an individual packaging portion detached from the reel of material for packaging agricultural products in accordance with the present invention;

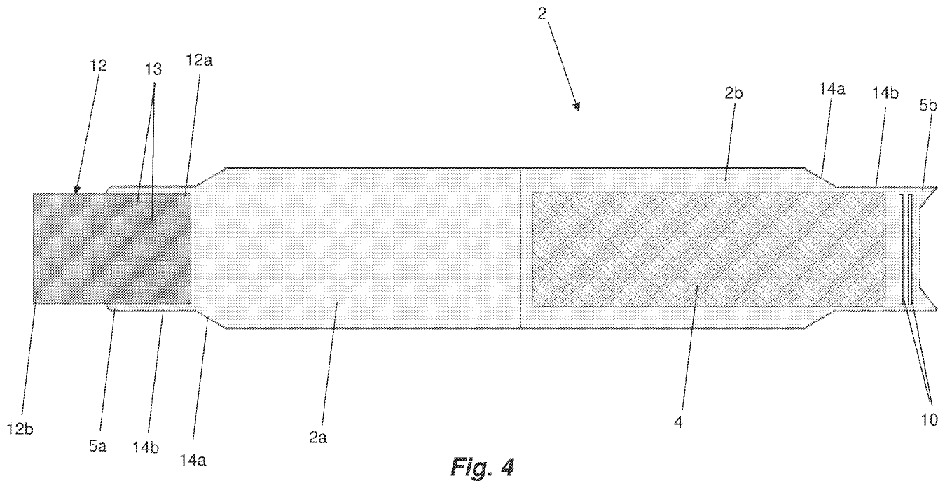

FIG. 5 shows a schematic side view of the material for packaging agricultural products, according to the present invention, being applied during the baling process within an automated harvesting machine; and

FIG. 6 schematically represents a production line that carries out the method of manufacturing a material for packaging agricultural products, according to the present invention.

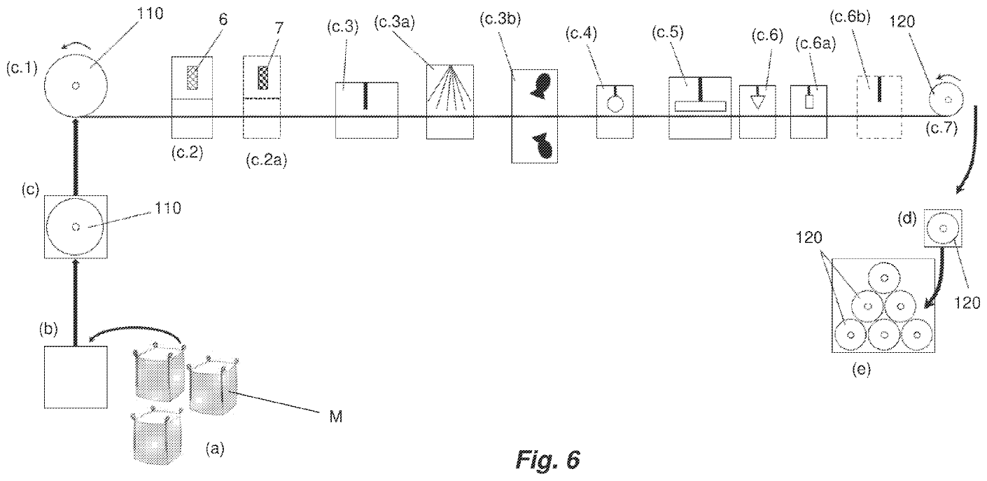

### DETAILED DESCRIPTION OF THE INVENTION

In accordance with the above, some examples of particular embodiments of the present invention will be described in more detail below, however, it is important to emphasize that this is a merely exemplary and non-restrictive description, since the material for packaging agricultural products, as well as the production method of this type of material for packaging agricultural products, may present different details and technical, constructive and functional characteristics without, therefore, interfering with the scope of protection defined and delimited by the content of the attached claims.

Therefore, it is important to highlight that the following description will be made with reference to the attached figures, which are schematic representations and only seek to exemplify and facilitate the understanding of the present invention. Therefore, it must be clear that the dimensions and/or proportions may not reflect reality, considering that the purpose of the figures is only to present the invention in the most didactic way possible. Furthermore, as should be appreciated by those skilled in the art, some details known and common in the art may have been omitted for better clarity and conciseness of the description of the present matter.

In this context, and particularly as represented by the attached schematic figures, the material for packaging agricultural products, object of the present invention, was designed and developed to be used, without being limited to this application, in automated harvesting machines, such as so-called harvesters. cotton, hay, straw and forage plants in general, which are configured to carry out harvesting in the field and also process and pack the harvested material into bales that are sequentially dumped in the field for another machine or equipment to collect and transport these bales to processing sites.

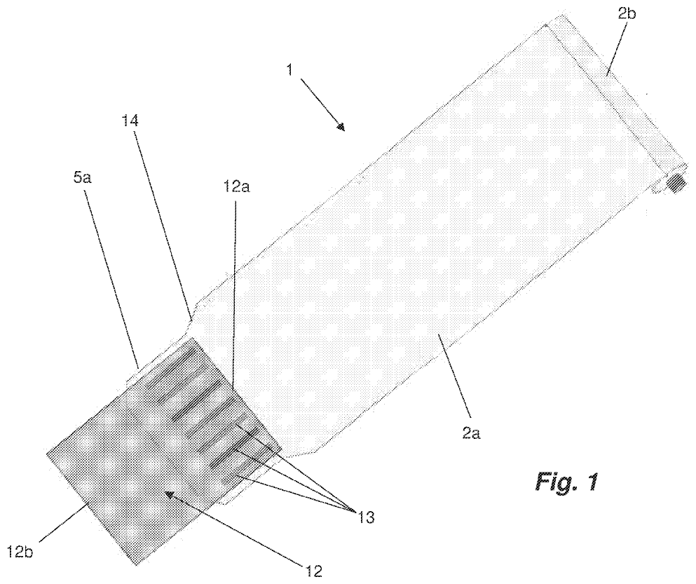

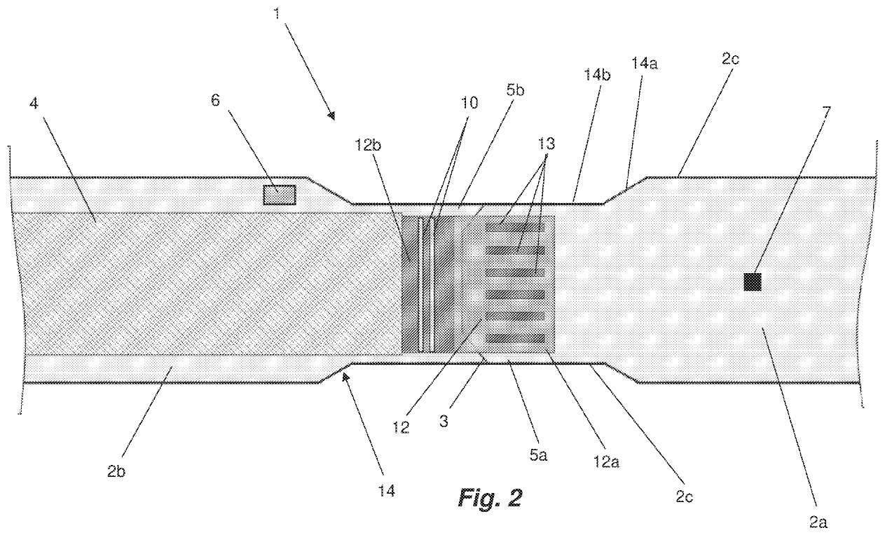

Thus, with particular reference to FIGS. 1 and 2, it is possible to observe that the new proposed material for packaging agricultural products, according to the present invention, is formed by a single and continuous film 1 composed of a plurality of individual packaging portions 2, detachable from each other by means of a tear line 3, each individual packaging portion 2 comprising an initial portion 2a and a final portion 2b. In a particular embodiment of the present invention, one of the surfaces of said continuous single film 1 may be, at least in part of its extension, coated with a layer of non-permanent type adhesive 4 on one of its surfaces, which may assist in closing the bale of agricultural product.

More specifically, this material for packaging agricultural products, according to the present invention, comprises a permanent adhesive 10 applied near the final end 5b of the final portion 2b, said permanent adhesive 10 being covered by a film 12, the end 12b of which overlaps this permanent adhesive 10, is bent to obtain a “V” configuration, and the opposite end 12a extends over the initial end 5a of the initial portion 2a of the subsequent individual packaging portion 2 where it is rigidly fixed.

It is worth noting that, according to particular embodiments of the present invention, the final end 5b of the final portion 2b of an individual packaging portion 2 has a configuration corresponding to the initial end 5a of the initial portion 2a of the subsequent individual packaging portion 2. Therefore, it is worth reiterating that the material for packaging agricultural products of the present invention is formed by a single and continuous film 1 and does not have any type of seam or union of portions of individual packaging 2. In this sense, it is also worth clarifying that said film 12 does not perform the function of joining between the portions of individual packaging 2, its purpose is to temporarily protect the permanent adhesive 10 while the present material for packaging agricultural products is wound on the coils.

It is worth pointing out that this film 12 can have a complementary function after separation of the individual packaging portion 2 and, particularly, at the moment of starting the baling process with the next individual packaging portion 2. More particularly, at this moment when the harvesting machine begins the baling process, the initial end 5a must be pulled or pulled by the baling mechanisms and, considering that the end 12b ends up being free after detaching from the final end 5b of the packaging portion individual predecessor 2, this end 12b of the film 12 can perform a launching reinforcement function in order to assist the introduction and initial guidance of the subsequent packaging portion 2 by the baling mechanisms.

The end 12a of said film 12 is firmly fixed to the initial portion 2a by fastening elements 13, which can be of any nature as long as they are capable of withstanding the traction forces generated by the harvesting machine at the time of separation of the portions of individual packaging 2. As will be appreciated by those skilled in the art, in the final phase of baling the harvested material, the mechanism supporting the coil with the packaging material is locked, while the baling mechanisms continue to pull the single, continuous film 1 until the portions of individual packages 2 separate due to break line 3. By way of example, these fastening elements 13 may be suitable solders, glues or adhesives.

Additionally, and more particularly with respect to the permanent adhesive 10, it is noted that this adhesive may be a glue or an adhesive tape applied to at least a portion along the transverse extent of the single, continuous film 1 near the final end 5b of the portion end 2b.

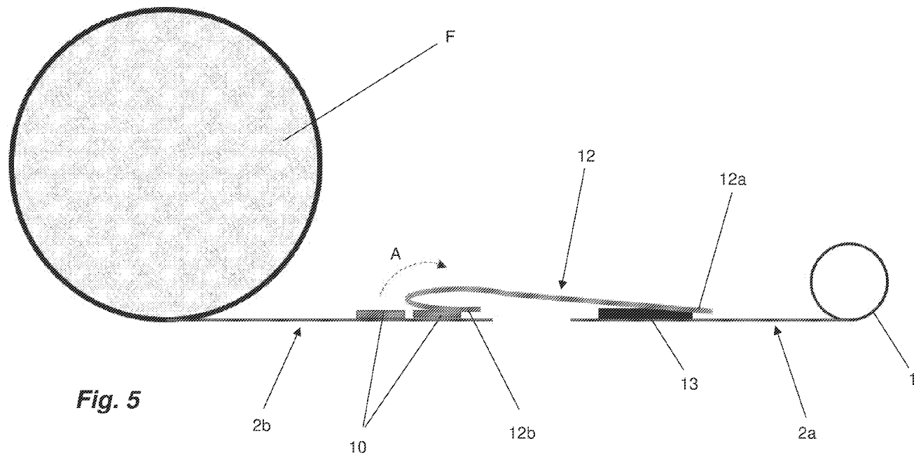

Just for clarification, FIG. 5 illustrates a representation of the final stage of applying the single and continuous film 1 to a bale (F), and at this final moment of the baling process, the coil with the material for packaging agricultural products is locked while the bale (F) continues to rotate and pull the single, continuous film 1. As shown, after breaking the tear line 3, the portion of individual packaging 2 being rolled into the bale (F) continues to move, while the subsequent portion of individual packaging 2 remains static, with this, the end 12b of said film 12 begins to peel away from the permanent adhesive layer 10 in view of the “V” configuration, as represented by the arrow (A). At the end, said layer of permanent adhesive 10 is completely exposed to be glued to the bale (F).

According to an optional embodiment of the present invention, the single and continuous film 1 of the material for packaging agricultural products may comprise, in the region of the rupture line 3, a refill-type narrowing 14, which may be carried out in at least one of its side edges 2c and, preferably, on both side edges 2c. The purpose of this narrowing 14 is to promote better conditions in conditioning and directing the rupture of the single and continuous film 1 in order to guide the separation of the portions of individual packages 2 with a low risk of forming burrs when separating the portions and closing the bale. Furthermore, this narrowing 14 may eventually help with gripping conditions in the final packaging and bale forming phase, so as to ensure that the bale is firmly locked.

According to another embodiment of the present invention, this narrowing 14 can be formed by the combination of an angular narrowing 14a and a complementary segment 14b, on which said film 12 is positioned and fixed, on one side by the fixing elements 13 and, on the other side, adhered to the permanent adhesive 10. This configuration of the narrowing 14, together with the application of the permanent adhesive 10, has the purpose of improving the rupture conditioning in the rupture line 3 and, also, forming a configuration that can improve the adhesion conditions in the final packaging and forming phase. of the bale inside the harvesting machines.

Also, according to another embodiment of the present invention, said single and continuous film 1 is a multi-layer plastic film containing layers responsible for protection against ultraviolet rays, impermeability and pigmentations to improve the internal conditions of the bale when exposed to heat, cold and humidity. More particularly, the single and continuous film 1 is characterized by the presence of barriers against these environmental and climatic interferences, such as humidity, water, solids, oxygen, etc. As should be appreciated, the plastic film, according to the present invention, has the ability to waterproof and seal the agricultural product as if it were in a packaging or wrapper capable of holding together the mass of harvested agricultural product, but mainly free of any contaminants that may depreciate the harvested material.

Optionally, this single and continuous film 1 is of low density and has physical and chemical stretching properties to, therefore, provide structural reinforcement in the formation of bales, considering that this stretching capacity combined with the other characteristics of the single and continuous film 1, allows the harvested material to be wrapped and, at the same time, to provide adhesion with a certain pressure between the surfaces of the single and continuous film 1 itself, which makes it possible to distribute the efforts usually generated by the natural expansion of the material along the surface of the bales. packaged and, as a result, an overload concentrated only in the region of said permanent adhesive 10 is avoided.

According to another embodiment of the present invention, said non-permanent type adhesive layer 4 can be applied on the individual packaging portion 2 in a proportion that can vary from 5-95% of the total length of said packaging portion. individual 2. More particularly, according to a preferred embodiment, said non-permanent type adhesive layer 4 can be applied over about 50% of the individual packaging portion 2, which means application over practically the entire length of the final portion 2b.

Additionally, according to other embodiments of the present invention, said rupture line 3, disposed between the packaging portions 2 of the single and continuous film 1, can be comprised of embrittlement points, pre-rupture points and/or weakening points. Alternatively, this rupture line 3 can be obtained using laser tools, using hot or cold metal knives, serrated cutting knives, straight cutting knives, pyramidal cutting knives, triangular cutting knives, as well as laser micro perforations, surface embrittlement or any other equivalent means. Furthermore, optionally, these rupture lines 3 may comprise reinforcement portions, which are constituted by non-weakened segments along the rupture line 3. The purpose of these reinforcement portions is to ensure the integrity of the continuous single film 1 during the production process, but to provide for the proper rupture of the line 3 and separation of the individual packaging portions 2 at the opportune moment within the harvesting machines.

According to a possible embodiment of the present invention, each packaging portion 2 of the single and continuous film 1 comprises at least one signaling means 6 responsible for promoting some type of interaction with the baling mechanisms of automated harvesting machines, particularly to allow adequate unwinding of the coils, winding of the bales and breaking of said portions of individual packaging 2 exactly at the break line 3. More preferably, according to constructive variants of the present invention, said signaling means 6 may be a photocell, a paint-based indication, a metallic paint, a metallic element, a marking, a demarcation, a bar code, a perforated code, or any other element capable of promoting the indication of the length of said portion of individual packaging 2 unrolled inside the machine.

It is worth highlighting that this signaling means 6 can also be used in packaging material production lines, so that the equipment used to manufacture this material is controlled by sensors that capture/identify these signaling means distributed along the length of the single film. and continuous 1.

Optionally, according to yet another embodiment of the present invention, said packaging portion 2 may comprise identifying means 7 whose purpose is to provide geographic identification of bales in the field when they are dumped by automated harvesting machines and await collection for transport to processing locations. These means of identification can significantly assist the logistics of field work, ensuring that all bales generated in the field by automated harvesting machines are properly collected and transported to processing centers, thus avoiding theft, theft, diversion and loss of the product. agricultural. By way of example, these identifying means 7 can be radio frequency labels/tags, such as so-called RFIDs, or any other technology capable of promoting this geographic identification and monitoring of bales.

Additionally, as mentioned above, the present invention also deals with a method for producing a material for packaging agricultural products, which is basically formed by the following steps:
a) produce a continuous plastic film, through the formulation of the raw material (M) and preparation of the film extruder;
b) produce said continuous plastic film in jumbo reels 110, which are subjected to inspection to be packaged and identified;
c) storing said jumbo reel 110 so that it can be applied to the single and continuous film production line 1, which comprises the steps of:
   c.1) unwind said jumbo reel 110;
c.2) positioning and applying at least one signaling means 6, such as a metallized label;
   c.3) executing a tear line 3 on said single and continuous film 1, which is responsible for projecting individual packaging portions 2, said break line 3 being disposed between the final portion 2b of an individual packaging portion 2 and the initial portion 2a of the subsequent individual packaging portion 2 formed by said single, continuous film 1;
   c.4) applying a permanent adhesive 10 close to the final end 5b of the final portion 2b;
c.5) accommodate a film 12 over the single, continuous film 1, so that the end 12b, which overlaps the adhesive 10, is folded forming a “V” configuration, and the opposite end 12a extends over the initial end 5a of the initial portion 2a of the subsequent individual packaging portion 2;
c.6) applying fixing elements 13 to the end 12a of said film 12;
   c.7) winding said single and continuous film 1 onto a reel 120 configured to be introduced into an automated harvesting machine;
d) inspect the reels 120 of single and continuous film 1 to be packaged and identified;
e) storing said reel 120 of single and continuous film 1.

According to a particular embodiment of the method of the present invention, after step (c.3) of forming the tear line 3 in said single and continuous film 1, it is possible to include a step (c.3a) of intermittent application of a layer of non-permanent type adhesive 4 on one of the surfaces of the single and continuous film 1, forming a portion without non-permanent type adhesive and a portion containing this non-permanent type adhesive 4. In this case, after applying said non-permanent type adhesive layer 4, the method of the present invention may also comprise a step (c.3b) to subject the single and continuous film 1 to a drying and adhesive absorption process. of non-permanent type 4 in a greenhouse.

Optionally, according to another embodiment of the method of the present invention, after step (c.6) of applying fixing elements 13 to the end 12a of said film 12, it is possible to also include a step (c.6a) of application of talcum powder close to the lateral edges 2c of the single, continuous film 1. This talcum powder is intended to provide better working conditions, particularly during the passage of said single and continuous film 1 through the baling mechanisms of automated harvesting machines.

Additionally, according to yet another embodiment of the method of the present invention, before the step (c.7) of winding said single and continuous film 1 onto a reel 120, it is possible to include a step (c.6b) for performing a nip 14, of the refill type, on at least one of the side edges 2c, and preferably, on both side edges 2c.

Additionally, according to another possible embodiment of the present invention, said step (c.3) related to obtaining the rupture line 3 is conducted through a process for the formation of weakening points, pre-rupture points and/or weakening points. This rupture line 3 is optionally obtained using laser tools, using hot or cold metal knives, serrated cutting knives, straight cutting knives, pyramidal cutting knives, triangular cutting knives, as well as laser micro perforations, surface embrittlement or any other equivalent means of obtaining the rupture line allowing the separation of said portions of packaging 2 during the baling process inside automated harvesting machines.

More particularly, according to some constructive variants of the present invention, said signaling means 6 applied during step (c.2) may be a photocell, a paint-based indication, a metallic paint, a metallic element, a marking, a demarcation, a bar code, a perforated code or any another element capable of promoting the indication of the length of said portion of packaging 2 unrolled within said harvesting machines and also in the single and continuous film production equipment 1.

Furthermore, according to another embodiment of the method of the present invention, after step (c.2) relating to the positioning and application of the signaling means 6, it is possible to include a step (c.2a) for applying at least one identifying means 7 whose purpose is to provide the geographical identification of bales in the field when they are dumped by automated harvesting machines and await collection for transport to processing sites. As mentioned above, these means of identification 7 assist the logistics of farmers' work, ensuring that all bales generated by automated harvesting machines have been properly collected and transported to the processing units, thus avoiding theft, theft, diversion and loss. of the agricultural product. By way of example, these identifying means 7 can be radio frequency labels/tags, such as so-called RFIDs, or any other technology capable of promoting this geographic identification and monitoring of bales.

According to a particular embodiment of the method of the present invention, in step (c.6) of applying fastening elements 13 to the end 12a of said film 12, said fastening elements 13 may be suitable solders, glues or adhesives.

Finally, in view of all the above, it is important to be clear that the sole purpose of this description is to define, by way of example, possible and preferred embodiments of the material for packaging agricultural products developed to be applied in automated harvesting machines, as well as related methods. for the manufacture of material for packaging agricultural products. Therefore, as those skilled in the art well understand, numerous modifications, variations and constructive combinations of elements that perform the same function in substantially the same way are possible to achieve the same results, and which must be included within the scope of protection delimited by the attached claims.

1. MATERIAL FOR PACKAGING AGRICULTURAL PRODUCTS, which is formed per a single and continuous film (1) which is composed of a plurality of individual packaging portions (2) that are detachable from each other through a tear line (3), said individual packaging portion (2) having an initial portion (2a) and a final portion (2b), wherein it also comprises a permanent adhesive (10) applied close to the final end (5b) of the final portion (2b), which is covered by a film (12) whose end (12b), which overlaps said permanent adhesive (10), is folded into a “V” configuration, and the opposite end (12a) extends over the initial end (5a) of the initial portion (2a) of the subsequent individual packaging portion (2) where it is attached.

2. MATERIAL FOR PACKAGING AGRICULTURAL PRODUCTS, according to claim 1, wherein the said continuous single film (1) can be, at least in part of its extension, coated with a layer of non-permanent adhesive (4) applied to one of its surfaces.

3. MATERIAL FOR PACKAGING AGRICULTURAL PRODUCTS, according to claim 1, wherein the said end (12a) of the film (12) is fixed to the initial portion (2a) of the individual packaging portion (2) through fixing elements (13).

4. MATERIAL FOR PACKAGING AGRICULTURAL PRODUCTS, according to claim 3, wherein the fastening elements (13) are solders, glues or adhesives.

5. MATERIAL FOR PACKAGING AGRICULTURAL PRODUCTS, according to claim 1, wherein the said permanent adhesive is a glue or an adhesive tape, which is applied to at least a portion along the transverse extent of the single, continuous film (1) near the end (5b) of the end portion (2b) of each portion of individual packaging (2).

6. MATERIAL FOR PACKAGING AGRICULTURAL PRODUCTS, according to claim 1, wherein the said single and continuous film (1) comprises, in the region of the rupture line (3), a narrowing (14) of the refill type.

7. MATERIAL FOR PACKAGING AGRICULTURAL PRODUCTS, according to claim 6, wherein the said narrowing (14) is carried out on at least one of its side edges (2c) and, more particularly, on both side edges (2c).

8. MATERIAL FOR PACKAGING AGRICULTURAL PRODUCTS, according to claim 6, wherein the said narrowing (14) is formed by the combination of an angular narrowing (14a) and a complementary segment (14b), on which said film (12) is positioned and fixed, on one side, through the elements (13) and, on the other side, adhered to the permanent adhesive (10).

9. MATERIAL FOR PACKAGING AGRICULTURAL PRODUCTS, according to claim 1, wherein the said single and continuous film (1) is a multi-layer plastic film with protection against ultraviolet rays, impermeability and with pigmentations, such as elements with characteristics of barriers against environmental and climatic interferences, such as humidity, water, solids and oxygen.

10. MATERIAL FOR PACKAGING AGRICULTURAL PRODUCTS, according to claim 1, wherein the said single and continuous film (1) is a low density film with physical and chemical stretching properties.

11. MATERIAL FOR PACKAGING AGRICULTURAL PRODUCTS, according to claim 2, wherein the said non-permanent type adhesive layer (4) is applied on the individual packaging portion (2) in a proportion that may vary from 5-95% of the total extent of said individual packaging portion (2).

12. MATERIAL FOR PACKAGING AGRICULTURAL PRODUCTS, according to claim 2, wherein the said layer of non-permanent adhesive (4) is applied to 50% of the individual packaging portion (2).

13. MATERIAL FOR PACKAGING AGRICULTURAL PRODUCTS, according to claim 1, wherein the said rupture line (3) is formed by weakening points, pre-rupture points and/or weakening points.

14. MATERIAL FOR PACKAGING AGRICULTURAL PRODUCTS, according to claim 1, wherein the along said rupture lines (3) reinforcement portions are arranged which are made up of non-weakened segments.

15. MATERIAL FOR PACKAGING AGRICULTURAL PRODUCTS, according to claim 13, wherein the said rupture line (3) is obtained using laser tools, hot or cold metal knives, serrated cutting knives, straight cutting knives, pyramid cutting knives, triangular cutting knives, or even such as laser micro perforations or surface embrittlement.

16. MATERIAL FOR PACKAGING AGRICULTURAL PRODUCTS, according to claim 1, wherein the each individual packaging portion (2) of said single and continuous film (1) comprises at least one signaling means (6), which may be a photocell, a paint-based indication, a metallic paint, a metallic element, a marking, a demarcation, a barcode, a perforated code.

17. MATERIAL FOR PACKAGING AGRICULTURAL PRODUCTS, according to claim 1, wherein the said individual packaging portion (2) comprises at least one identifying means (7), such as radio frequency labels/tags—RFIDs.

18. METHOD OF PRODUCING A MATERIAL FOR PACKAGING AGRICULTURAL PRODUCTS, wherein understanding the following steps:
a) produce a single and continuous plastic film (1), through the formulation of the raw material and preparation of the film extruder;
b) producing said single and continuous plastic film in reels (110), of the jumbo type, which are subjected to inspection to be packaged and identified;
c) storing said jumbo reel (110) so that it can be applied to the single and continuous plastic film production line (1) where the following steps are carried out:
c.1) unwind said jumbo reel (110);
c.2) position and apply the signaling means (6), such as a metallized label;
c.3) execute a rupture line (3) in said single and continuous film (1), which is responsible for projecting portions of individual packages (2), with this rupture line (3) being arranged between the portion end (2b) of an individual packaging portion (2) and the initial portion (2a) of the subsequent individual packaging portion (2) formed by said single and continuous film (1);
c.4) apply a permanent adhesive (10) close to the final end (5b) of the final portion (2b);
c.5) accommodate a film (12) over the single and continuous film (1), so that the end (12b), which overlaps the permanent adhesive (10), is folded forming a “V” configuration, and the opposite end (12a) extends over the initial end (5a) of the initial portion (2a) of the subsequent individual packaging portion (2);
c.6) applying fixing elements (13) to the end (12a) of said film (12);
c.7) winding said continuous single film (1) onto a reel (120) to be introduced into an automated harvesting machine;
d) inspection of the reels (120) of single and continuous film (1) to be packaged and identified;
e) storing said reel (120) of single and continuous film (1).

19. METHOD, according to claim 18, wherein after step (c.3), it comprises the following additional steps:
c.3a) intermittent application of a layer of non-permanent adhesive (4) on one of the surfaces of the single and continuous film (1), forming a portion without non-permanent adhesive and a portion containing said adhesive non-permanent type (4); It is
c.3b) subject the single and continuous film (1) to a drying and absorption process of the non-permanent adhesive (4) in an oven.

20. METHOD, according to claim 18, wherein after step (c.6), it comprises the following additional step:
c.6a) apply talcum powder close to the side edges (2c) of said single and continuous film (1).

21. METHOD, according to claim 18, wherein, before step (c.7), it comprises the following additional step:
c.6b) performing a narrowing (14), of the refill type, on at least one of the side edges (2c), and preferably, on both side edges (2c) of said individual packaging portion (2).

22. METHOD, according to claim 18, wherein the said step (c.3) is conducted through a process of formation of weakening points, pre-rupture points and/or weakening points.

23. METHOD, according to claim 18, wherein during said step (c.3), the rupture line (3) is obtained using laser tools, with hot or cold metal knives, serrated cutting knives, straight cutting knives, pyramidal cutting knives, triangular cutting knives, with laser micro perforations or surface embrittlement.

24. METHOD, according to claim 18, wherein during said step (c.2) the signaling means (6) is a photocell, a paint-based indication, a metallic paint, a metallic element, a marking, a demarcation, a bar code or a punched code.

25. METHOD, according to claim 18, wherein after step (c.2), said continuous plastic film (1) is subjected to a step of inclusion of at least one identifying means (7), such as radio frequency labels/tags—RFIDS.

26. METHOD, according to claim 18, wherein the said step (c.6), said fastening elements (13) are solders, glues or adhesives.
